(19) United States
(12) Patent Application Publication
(10) Pub. No.: US 2011/0106704 A1
(43) Pub. Date: May 5, 2011

(54) SYSTEM AND METHOD TO REALIZE INSTANT, GUARANTEED PAYMENTS FOR BUSINESS-To-BUSINESS (B2B)

(76) Inventors: Rene Babi, Vancouver, WA (US); Mark Silbernagel, Battle Ground, WA (US)

(21) Appl. No.: 12/916,385

(22) Filed: Oct. 29, 2010

Related U.S. Application Data
(60) Provisional application No. 61/256,279, filed on Oct. 29, 2009.

(51) Int. Cl. G06Q 40/00

(52) U.S. Cl. 705/44

(57) ABSTRACT

A method is disclosed for transferring funds between two business entities. The method includes the steps of including a first business entity transmitting a purchase order to a second business entity, the second business entity transmitting an authorization request to a payment processor, sequestering a first amount of money in an account associated with the first business entity, based in part on an amount indicated in the purchase order, granting preliminary access to a second amount of money in an account associated with the second business entity, and removing the sequestered first amount of money from the account associated with the first business entity and depositing the second amount of money to the account associated with the second business entity.

### CROSS REFERENCE TO RELATED APPLICATIONS

This application claims the benefit of U.S. Provisional Application No. 61/256,279, filed Oct. 29, 2009 and entitled “System and Method to Realize Instant, Guaranteed Payments, B2B”, which is incorporated herein by reference it its entirety.

### FIELD OF THE INVENTION

The present invention relates generally to business-to-business (B2B) transactions and more particularly to a system and method for facilitating transfer of funds between two businesses.

### BACKGROUND OF THE INVENTION

In the United States, traditionally, payments of any significance between business entities are accomplished using either checks or bank facilitated (web initiated) funds transfers through the national automated clearing house association's network (NACHA: ACH). In both cases, such payments suffer from several drawbacks associated with an aging system first designed for use by financial institutions in the 1700s. The assumptions of that day continue to affect today's implementations, that is, a scheduled (not real time) exchange of messages between banks and/or businesses to request funds and in turn acknowledge the request in the affirmative or if negative accompanied by some indication of why the request was turned down. Such exchanges could then, and now, take days to accomplish.

Negative responses, a day or days later, might indicate an invalid or closed account, or that there are insufficient funds to satisfy the request. Additionally, the owner of the account from which funds are being withdrawn can later (3-4 months later, in some cases) revoke the transfer, resulting in a transaction reversal. Obviously, the funds may have long since been transferred or used elsewhere, leaving the intermediary party—bank or business—with the loss of both goods/services rendered and monies originally received; the antithesis of a ‘good funds’ model, and that possibly long after the initial request.

While the debit/credit networks provide a much more positive (real-time) request-response mechanism to address some of the drawbacks associated with checks and ACH, they are primarily designed for consumers and not business-to-business transactions of any magnitude.

Further obstacles are introduced by consumer oriented safety laws associated with debit/credit instruments, that subject the near instant debit/credit network transaction to the same reversal (buyer remorse, or worse) as an ACH; i.e. not subject to sufficient review to guarantee payments upon performance of the original contract and reversal only upon review and confirmation that the contract was somehow incomplete or unfulfilled—again according to contractual terms. Such laws were primarily designed for individual consumer transactions, not business to business transactions.

Wire transfers are an alternative that solve the ‘good funds’ model, but tend to be more expensive and not as accessible to business automation.

What is needed is a system and method for facilitating real-time and guaranteed funds transfer for business-to-business (B2B) transactions.

### BRIEF DESCRIPTION OF THE DRAWINGS

FIG. 1 shows a sequence diagram outlining the steps performed during an exemplary transaction in accordance with a method of the present invention.

FIG. 2 shows a flow chart of the relevant steps for transacting in a manner consistent with an exemplary method of the present invention.

FIG. 3 shows some of the structures used to implement the steps of FIGS. 2 and 3, in accordance with an apparatus of the present invention.

### SUMMARY OF THE INVENTION

Briefly, a method of the present invention for transferring funds between two business entities includes the steps of including a first business entity transmitting a purchase order to a second business entity, the second business entity transmitting an authorization request to a payment processor, sequestering a first amount of money in an account associated with the first business entity, based in part on an amount indicated in the purchase order, granting preliminary access to a second amount of money in an account associated with the second business entity, and removing the sequestered first amount of money from the account associated with the first business entity and depositing the second amount of money to the account associated with the second business entity.

These and other objects and advantages of the present invention will no doubt become apparent to those skilled in the art after having read the following detailed description of the preferred embodiments illustrated in the several figures of the drawing.

### DETAILED DESCRIPTION

In accordance with various embodiments and methods of the present invention, a system and method is disclosed for using the debit-credit model of pre-authorization/confirmation (post) for real-time validation of a business account used for transactions, determination of account status, confirmation of the presence of sufficient funds, and the sequester of the requested funds (upon approval) until a transaction is completed; such as when goods are shipped or as otherwise directed by the terms of agreements guiding the transaction. Such system and method provide solutions to all the drawbacks listed above: timing, status, and positive acquisition of funds.

When implemented by a trusted third party whose behavior is governed in an escrow-like fashion as directed by contract, the matter of ‘good funds’ is also now brought to an acceptable level of risk and performance for most business transactions.

To better understand the operation of and various components and steps of the embodiments of the present invention, the discussions to follow use an example of a transaction between two business entities, “A” and “B”, for the sale of goods/services. In this regard, “A” and “B” are each considered a business entity.

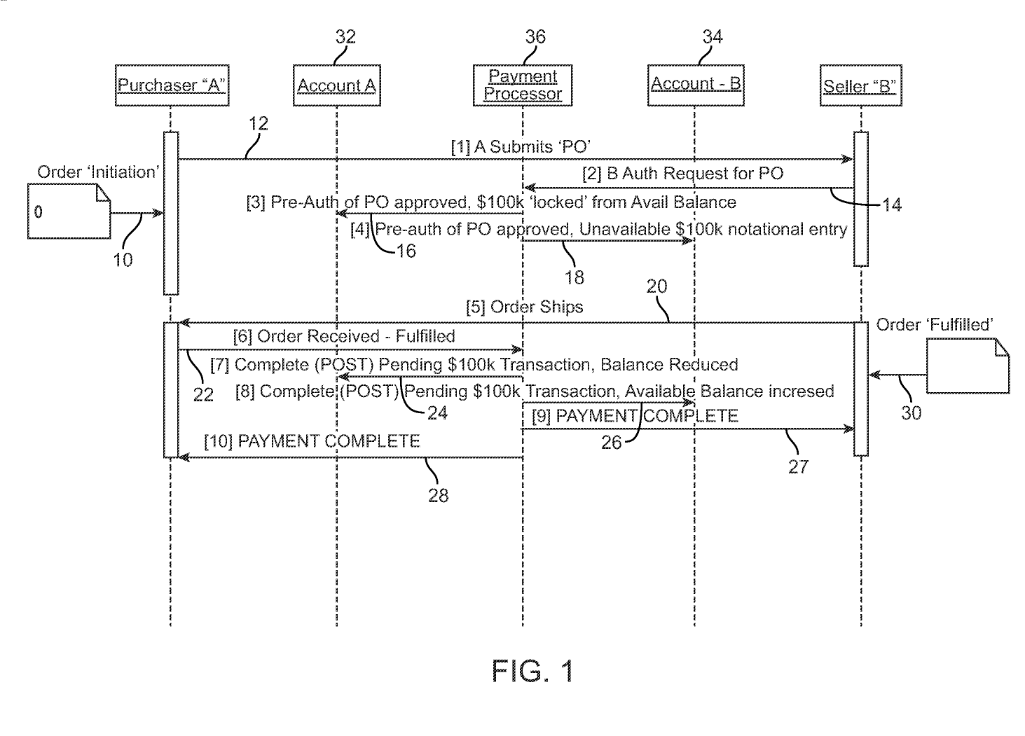

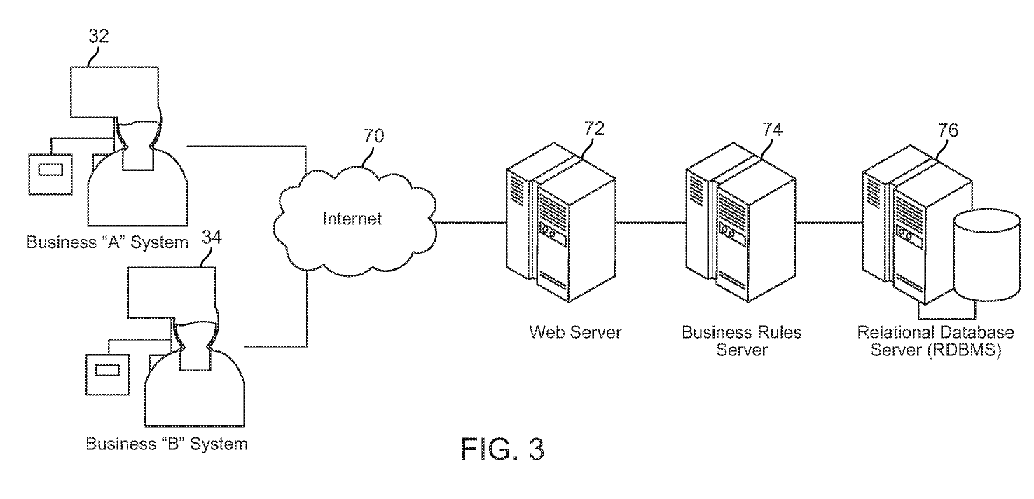

FIG. 1 shows a sequence diagram outlining the steps performed during an exemplary transaction in accordance with a method of the present invention. Initially, at step 10, an order is initiated by purchaser “A”, generally a business, where resulting in a purchase order (PO), at step 12, being submitted to the seller “B”, also generally a business. Next, B authorizes the request for the PO at step 14 to a payment processor 36. Stated differently, within A's business systems, at steps 10 and 12, a requisition is approved against the appropriate cost-center and budget, generating a PO, which then accompanies the electronic order to B's business systems. B's business systems may validate and approve the order, and may send a message, at step 14, to the proposed system (in this case, a payment processor 36) which includes, for example, the purchase order identification (ID)/number, amount requested, and any further information necessary. Using the PO ID, the payment processor 36 verifies the correct company is attempting to use the PO, that the amount is within bounds of what was approved for the PO, and that sufficient funds are ‘on account’ with A. The payment processor 36 can be the servers 72, 74 and 76 shown and discussed herein relative to FIG. 3, in one embodiment of the present invention. The web server 72 performs functions such as accept messages from businesses via the Internet 70 (shown in FIG. 3) in various formats typically conforming to various industry standards such as EDI X.12 but possibly using message or file formats that are proprietary in nature. It also performs functions such as formatting the messages to a standardized and internal form and passing them to the business rules server 74. The business rules server 74, of FIG. 3, messages are received from the web server 72 in standard form, logged, and processed appropriately. Rules and steps which require information such as account balances, etc. cause a query to be directed to the relational database server 76. The relational database server 76 stores various information relating to accounts, account balances, limits, and any other information over periods of time are kept, typically using a relational database which in turn organizes the information on mass storage (hard drives, or disks) and makes them accessible to the business rules server 74 as needed. In summary, at step 16, the payment processor 36 pre authorizes or approves the PO upon verifying that sufficient funds are in A's account 32 (Account A). To accomplish a step such as “payment processor verifies A's account has sufficient funds”, the message (14, FIG. 1) sent to payment processor (36, FIG. 3) arrives from T over the internet (70, FIG. 3) in the form of a message in format specified by (example) EDI X.12. The web server (72, FIG. 3) converts the message into a standardized form and passes it to the business rules server (74, FIG. 3) where the question is asked (“are there sufficient funds?”). The business rules server queries the database (76, FIG. 3) using a standard protocol or means (e.g. JDBC, original diagram) between server 74 and server 76. The account balance is maintained in the RDBMS on server 76 of FIG. 3. The balance is returned to the Business Rules Server 74 (FIG. 3) where a comparison is made between the amount desired and the amount on file and the answer can be known (yes/no).

Once the request is validated and found acceptable by the payment processor 36, the requested funds are sequestered at step 16 (as with a debit card pre-authorization) pending the consummation of the transaction, during which time the sequestered funds may be inaccessible for withdrawal by A, though in some embodiments of the present invention, they may continue to accrue interest on behalf of A. Simultaneously, B's account, Account B 34 receives a preliminary adjustment in its balance by the amount requested, as shown at step 18 where the pre-authorization of the PO is approved and the funds (in this example $100,000) remains unavailable for use by (or sequestered as to) B in addition to A. This may be perceived analogously as ‘memo’ posting and the purpose of this ‘memo’ posting is to document that ‘good funds’, which are immediately available funds, are in fact being held in escrow awaiting consummation of the contract or transaction.

Eventually, the order ships, at step 20, subsequently arriving at A's receiving dock (in this example). A's receiving dock examines the shipment and confirms delivery of undamaged goods of the correct type and quantity. Upon entering this information into A's systems by the receiving clerk, a message is sent from A's business systems to the payment processor 36, at step 22, causing the previously sequestered funds to be withdrawn from A's account, at step 24, and transferred to B's account, at step 26. Both seller and buyer are now notified of completed payment transaction and updated funds availability—step 27 and step 28.

In this example, there was not a ‘receivable’ because funds were exchanged as soon as the terms of the order contract were confirmed. There were no payables because funds were released upon acknowledgement of receipt of the complete order. Between the time the order was placed and when receipt of the order was acknowledged—A's funds continued to accrue interest in payment processor 36's system, and B had a demonstrable order with confirmed payment awaiting which could be leveraged with a financial institution if a loan were required in order to fulfill the order (for example); essentially, a factoring of the order as a semi-liquid asset.

In a version of the above transaction, payment processor 36 may transfer to B's account a different amount of A's funds than was previously sequestered. Payment processor 36 may transfer to B an amount less than previously sequestered. For example, if B's shipment of goods is partial or defective, A may inform payment processor 36 that half of the transaction has arrived, and half of the funds may be immediately released to B. B may need to then confirm that only half of the shipment has in fact been shipped. Payment processor 36 may transfer to A an amount greater than previously sequestered. For example, A may offer an additional amount of money if the goods are shipped within a certain timeframe. Alternatively, parties A and B may agree that if a given condition precedent occurs, then B is entitled to interest earned on the sequestered funding while the transaction is pending, not A.

The time elapsed between confirmation of order receipt (terms complete) and delivery of payment may be on the order of seconds.

The risk that funds will be withdrawn subsequent to consummating the transaction may be subject only to confirmation that the order was not in fact completed according to contract terms.

In an embodiment, a trusted third party may provide the banking accounts/payments services as product offerings, possibly as an “Industrial Bank” to companies A and B, which use the third party's enterprise business software (for example, “SAP”). A & B's enterprise systems software, which may include the classic functions such as Purchasing, General Ledger, Payables, Receivables, etc. may have a ‘module’ (licensed extension or add-on of the basic system) which may link to the third party processing center under a subscription service (Software As A Service—“SAAS”), so that sensitive functions may be performed in a centralized, secure facility.

A's business systems and B's business systems may be in electronic communication with the proposed system, payment processor 36. Payment processor 36 may comprise a communication module, a verification module, and a funds transfer module. The payment processor 36 may also comprise other modules that may be useful to facilitate funds transfer. For example, payment processor 36 may additionally comprise encryption, authentication, or visualization modules to create a secure transfer of funds or to allow one or more operators to visualize the funds transfer process. All of the modules may be in communication with the other modules. The modules may operate on one or more systems, and the systems may be in communication with each of the other systems. The system or systems may be in communication with other entities or other systems via one or more networks.

The communication module may be operable to communicate with business systems. In the example above, the communication module may be operable to communicate with A's business systems and B's business systems. The communication may be via one or more networks, and the communication module may be operable to receive information from one or more business systems and transmit information to one or more business systems. The communication module is represented by the web server (72, FIG. 3). Messages arrive almost exclusively via secure communications across the internet (70, FIG. 3). If the exception were the arrival of a paper document via US mail, then the staff would probably pull up a web page and manually enter the contents of the document into a web page which would then reach our system through that same internet portal (70, FIG. 3), reaching the web server (72, FIG. 3), being transformed into a standardized message format and passed to the business rules server (74, FIG. 3) when it is processed appropriately.

The verification module may be operable to receive notification of shipment status. If the shipment is successful between two entities, the verification module may communicate with the funds transfer module to complete the funds transfer between the two entities. The verification module may also be operable to cancel the transfer of funds between two entities. The verification module of the present invention is that collection software which implements the verification steps, and ‘runs’ in our example of FIG. 3 on Business Rules Server 74.

The funds transfer module may be operable to communicate with business systems and/or bank systems to sequester funds in one or more accounts, to create provisional availability of funds in one or more accounts, and/or to transfer funds from one account into another account. The funds transfer module may have authorization from one or more entities to transfer funds, sequester funds, and/or make funds provisionally available in the entity's account. Similarly to the verification module, the funds transfer module operates on the business rules server—in an embodiment of the present invention, it is implemented as a module in JAVA—and is called as needed by other modules as part of processing or responding to an external message, all running within that server.

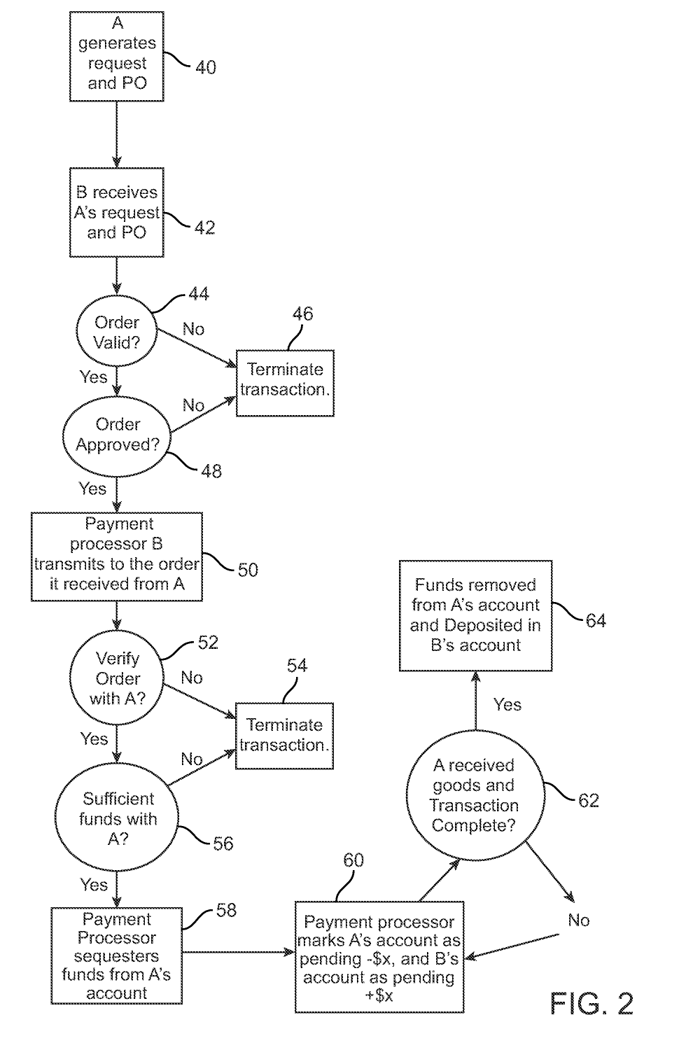

FIG. 2 shows a flow chart of the relevant steps for transacting in a manner consistent with an exemplary method of the present invention. It is noted that many of the steps of FIG. 2 are analogous to those shown and discussed relative to FIG. 1. The format of the messages accommodated by the various embodiments of the present invention use commonly available business methods and formats such as those defined by the EDI standard X.12 (http://en.wikipedia.org/wiki/Electronic_Data_Interchange). Proprietary message formats would be processed as well—as need dictates and would be driven in part by business entities A and B. Continuing, in the first step (40 of FIG. 2) business entity A's systems might be running the commercially available product “SAP” on their mainframe—which SAP is then configured to route those messages to the payment processor (present invention). The messages would arrive across the internet (70 FIG. 3) and be received by our server (72 FIG. 3) which normalizes the messages to an internal standard for processing on the business rules server (74, FIG. 3). The state diagram in FIG. 1 shows this message (40, FIG. 2) as message 12 (12, FIG. 1). The step 40 of FIG. 2 entails the message passing through and in doing so, being operated upon as described herein, and as needed passed to Business A or Business B by leaving the business rules server (74, FIG. 3), being formatted as needed for a particular business's needs on the web server (72, FIG. 3) and passing through the internet (70, FIG. 3) in the most appropriate format (e.g. EDI, some other standard, or perhaps even a proprietary format for a particular vendor—we don't care, it's not part of the invention). Step 42 FIG. 2 is accomplished as message 12 FIG. 1 leaves business entity “A's” systems, passes through the invention of FIG. 3 in the sequence 70->72->74->76->74->72->70 to business entity“B”. Message 14 then takes a similar path from system B, leaving their business system (perhaps SAP also, perhaps something else, we don't care), passing through the internet (70, FIG. 3), reaching our web server (72, FIG. 3) being processed by the biz rules server (74, FIG. 3)—and accessing persistent storage (the RDBMS on DB server 76 FIG. 3 as required. Steps operating on a message from a business (A or B) follow this pattern. At step 40, A generates a request and a PO. Next, at step 42, B receives A's request and PO. Next, at step 44, a determination is made as to whether or not A's order is valid and if it is determined that it is, step 48 is performed next where a determination is made as to whether or not the order placed by A is approved by B. This is done by matching the PO sent by A, previously stored on server 78 (FIG. 3) with message 14 (FIG. 1)—message 14 is business “B”s means of confirming that the order will be accepted if payment is approved. If at 44, it is determined that the order is not valid [no match], the process continues to step 46 where the transaction that was begun by A at step 40 is terminated. Termination is typically accomplish by responding with a negative response to message 14 (FIG. 1)—the denial is not shown in that figure. Similarly, if at 48, it is determined that the order is not approved, the process proceeds to step 46 where the transaction is terminated.

If the order is approved at 48, the process proceeds to step 50 where B transmits to the payment processor 36 the order it received from A. Next at 52, the order is verified with A and if the verification fails, the process continues to step 54 where the transaction is terminated but if the verification succeeds, the process continues to 56 where a determination is made as to whether or not there is sufficient funds in A's account, i.e. account A 32 in FIG. 1. If the determination at 56 yields a positive result, the process continues to step 58 but if insufficient funds are detected at 56, the process continues to step 54 and the transaction is terminated.

At step 58, the payment processor 36 sequesters funds from account A 32 and next, at step 60, the payment processor 36 marks the account A 32 as pending minus the amount that the transaction involved, or ‘$x’, and B's account, account B 34 is also marked as pending but plus $x. Next, at 62, a determination is made as to whether or not A received goods and the transaction was completed and if this determination yields a negative result, the process goes back to step 60 where step 60 and 62 are repeated until the determination at 62 yields positive results and the goods involved in the transaction are determined to have been received and the process proceeds to step 64. At step 64, the funds, $x, are removed from A's account, account A 32, and deposited into account B 34 and the transaction is considered completed.

FIG. 3 shows some of the structures used to implement the steps of FIGS. 2 and 3, in accordance with an apparatus of the present invention. In FIG. 3, account A 32 and account B 34 are shown to communicate through the Internet 70 to the web server 72, which is shown to be in communication with the business rules server 74, which is shown to be in communication with the relational database server 76.

Examples of some of the various software/hardware that may be employed in or operate with the structures shown in FIG. 3 are listed as follows:

Communicate through the Internet 70 to the web server 72 uses transmission methods or protocols such as T1, Secure Web Screen, e.g. HTTPS, Mobile Web Screen, e.g. HTTPS, Secure File Transfer, e.g. SFTP, Secure e-mail, e.g. SMTP, document delivery, e.g. paper, or electronic data interchange, e.g. EDI.

The computing platform shown in FIG. 3 as consisting of three servers (72, 74, 76) is exemplary and does not limit the invention from using alternate means. A mainframe might be used which implements all three logical functions (web, business rules, database) or perhaps a cloud computing environment with many virtual systems load sharing the function of “Web Server” implemented in our example as 72 of FIG. 3. All of these choices are obvious and common to those skilled in the disciplines of Information Systems. In our example, we might choose a hardware vendor from, say, HP, Dell or IBM server and then install an operating system from choices such as Linux, or Windows, and then implement the invention using a language choice of JAVA, or C#, running within an application server such as IBM WebSphere or JBOSS. While the invention requires such choices to put into practice, it can be done using an almost infinite variety of hardware and software solutions. It is understood that the foregoing list of software/hardware are merely examples of those that may be used and other implementations are contemplated.

The server 76 performs the steps 16 and 18 of FIG. 1 and causes account balance updates to the accounts 32 and 34, as indicated relative to steps 22 and 24 and the server 72 performs the steps 14 and 16 as well as sending messages to A and B, in steps 27 and 28, above.

Although the present invention has been described in terms of specific embodiment, it is anticipated that alterations and modifications thereof will no doubt become apparent to those more skilled in the art. It is therefore intended that the following claims be interpreted as covering all such alterations and modification as fall within the true spirit and scope of the invention.

What is claimed is:

1. A method for transferring funds, comprising:
a first business entity transmitting a purchase order to a second business entity;
the second business entity transmitting an authorization request to a payment processor;
the payment processor sequestering a first amount of money in an account associated with the first business entity, based in part on an amount indicated in the purchase order;
the payment processor granting preliminary access to a second amount of money in an account associated with the second business entity; and
the payment processor removing the sequestered first amount of money from the account associated with the first business entity and depositing the second amount of money to the account associated with the second business entity.

2. The method according to claim 1, where the first amount of money is identical to the second amount of money.

3. The method according to claim 1, additionally comprising the second business entity fulfilling the terms associated with the purchase order.

4. The method according to claim 3, where the step of fulfilling the terms associated with the purchase order comprises:
the second business entity delivering goods to the first business entity;
the first business entity examining the goods; and
the first business entity transmitting the status of the goods to the payment processor.

5. The method according to claim 4, where the first business entity transmits data to the payment processor indicating the purchase order is fulfilled.
